(19) United States
(12) Patent Application Publication
(10) Pub. No.: US 2013/0222337 A1
(43) Pub. Date: Aug. 29, 2013

(54) TERMINAL AND METHOD FOR DETECTING A TOUCH POSITION

(71) Applicant: Pantech Co., Ltd., (US)

(72) Inventor: Ha Wone LEE, Seoul (KR)

(73) Assignee: Pantech Co., Ltd., Seoul (KR)

(21) Appl. No.: 13/706,775

(22) Filed: Dec. 6, 2012

(30) Foreign Application Priority Data
Feb. 29, 2012 (KR) 10-2012-0020920

(51) Int. Cl. G06F 3/044

(52) U.S. Cl. CPC G06F 3/044
USPC 345/174

(57) ABSTRACT

A terminal includes a touch panel to detect a capacitance value associated with a touch input on a pattern portion, the touch panel including a plurality of channels and at least one of the channels includes a first pattern and a second pattern, a controller to determine whether the capacitance value of the pattern portion has at least a first threshold value and to determine whether a capacitance value of a portion of the pattern portion has at least a second threshold value, and a processing unit to recognize first sensing coordinates corresponding to the capacitance value of the pattern portion if the capacitance value is determined to have at least the first threshold value, and to recognize second sensing coordinates if the capacitance value of the portion of the pattern portion has at least the second threshold value.

### CROSS-REFERENCE TO RELATED APPLICATIONS

This application claims priority from and the benefit under 35 U.S.C. §119 of Korean Patent Application No. 10-2012-0020920, filed on Feb. 29, 2012, the entire disclosure of which is incorporated herein by reference for all purposes.

### BACKGROUND

1. Field

The following description relates to a terminal and a method for detecting a touch position a touch position, and more particularly, to a terminal having a touchscreen capable of recognizing a larger number of channels and patterns than a number of channels supported by a controller, and a touch position detecting method of the same.

2. Discussion of the Background

In general, a touchscreen is a display device designed so that when a user directly touches a screen with a finger, a touch pen having a ballpoint pen shape, or the like, a portable terminal recognizes the location where the contact occurs to execute a command or move the position of a cursor.

Touchscreens are classified into various types including resistive types (i.e., pressure reduction types), optical types, capacitive types (i.e., electrostatic types), ultrasonic wave types, and/or pressure types. The type of touchscreen incorporated into the display device may be based on one or more implementation principles and operation methods.

The touchscreens attached to mobile phones, smartphones, tablet personal computers (PCs), and the like may be classified into the resistive types (i.e., the pressure reduction types) and the capacitive types (i.e., the electrostatic types).

Particularly, the capacitive type (i.e., electrostatic type) touchscreen includes a transparent electrode. The transparent electrode may be formed by coating a transparent conductive material on both surfaces of a glass included in a sensor, in which a predetermined amount of current is passed through the surface of the glass.

When a conductive material, such as the human body including a finger or an electrostatic touch pen, contacts or approaches the transparent electrode, which is a sensor electrode, a parasitic capacitance is changed. The capacitive touchscreen senses such a change and recognizes the touch position.

FIG. 1 is a conceptual diagram of a general capacitive type (i.e., electrostatic type) touchscreen. The touchscreen forms a sensor electrode in the X axis and the Y axis and extracts position coordinates according to a change in capacitance detected in one or more channels of the X and Y axes. Coordinates may refer to an intersection between channels (e.g., a channel from the X axis and a channel from the Y axis).

When a controller having m+n channels is used, m channels may be arranged in the X axis, and n channels may be arranged in the Y axis.

Accordingly, as shown in FIG. 2, in the X axis of a touch panel, m patterns are formed, and in the Y axis, n patterns are formed, to constitute m×n cells.

In the general touchscreen, only the same number of patterns as the number of channels may be supported by the controller implemented in the touch panel, and thus the number of cells that may be implemented in the touch panel may be limited.

Further, as the screen of a terminal is increased in size, the size of the touchscreen may correspondingly increase.

However, if the touchscreen that has been increased in size is implemented by using an existing controller having a limited number of channels, there may be a problem in that the interval between the patterns may be increased and the touch precision may be degraded.

Accordingly, in order to maintain the touch precision of the touchscreen that has been increased in size, a revised controller having a larger number of channels than a general controller in the related art has to be used, or an additional controller(s) has to be added.

However, if the touchscreen is implemented using the revised controller having a larger number of channels than the general controller in the related art, the size of the controller mounted in a printed circuit board may be increased to be larger than the general controller. Accordingly, there may be some problem in securing space in the display device to accommodate the larger controller and costs may also be increased.

In addition, even in the case where the touchscreen is implemented by adding an additional controller(s), there may be a problem in securing a space to accommodate two controllers. Further, costs may be increased in securing additional space and adding additional controller(s).

### SUMMARY

Exemplary embodiments of the present invention provide a terminal and a method for detecting a touch position.

Additional features of the invention will be set forth in the description which follows, and in part will be apparent from the description, or may be learned by practice of the invention.

Exemplary embodiments of the present invention provide a method for detecting a touch input including detecting a capacitance value on a pattern portion of a touch panel with respect to a touch input unit; determining whether the capacitance value has at least a first threshold value; recognizing first sensing coordinates corresponding to the capacitance value of the pattern portion if the capacitance value is determined to have at least the first threshold value; determining whether the capacitance value of a portion of the pattern portion is above a second threshold value; and recognizing second sensing coordinates if the capacitance value of the portion of the pattern portion has at least the second threshold value, in which the touch panel includes a plurality of channels and at least one of the channels includes a first pattern and a second pattern.

Exemplary embodiments of the present invention provide a terminal including a touch panel to detect a capacitance value associated with a touch input on a pattern portion, the touch panel including a plurality of channels and at least one of the channels includes a first pattern and a second pattern; a controller to determine whether the capacitance value of the pattern portion has at least a first threshold value and to determine whether a capacitance value of a portion of the pattern portion has at least a second threshold value; and a processing unit to recognize first sensing coordinates corresponding to the capacitance value of the pattern portion if the capacitance value is determined to have at least the first threshold value, and to recognize second sensing coordinates if the capacitance value of the portion of the pattern portion has at least the second threshold value.

Exemplary embodiments of the present invention provide a terminal including a touch panel to detect a capacitance value associated with a touch input; and a processing unit to sense a coordinate on the touch panel corresponding to the capacitance value, and to determine validity of the coordinate based on the capacitance value, in which the touch panel includes a plurality of channels with at least one channel comprising a plurality of patterns.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a conceptual diagram of a general capacitive type (i.e., electrostatic type) touchscreen.

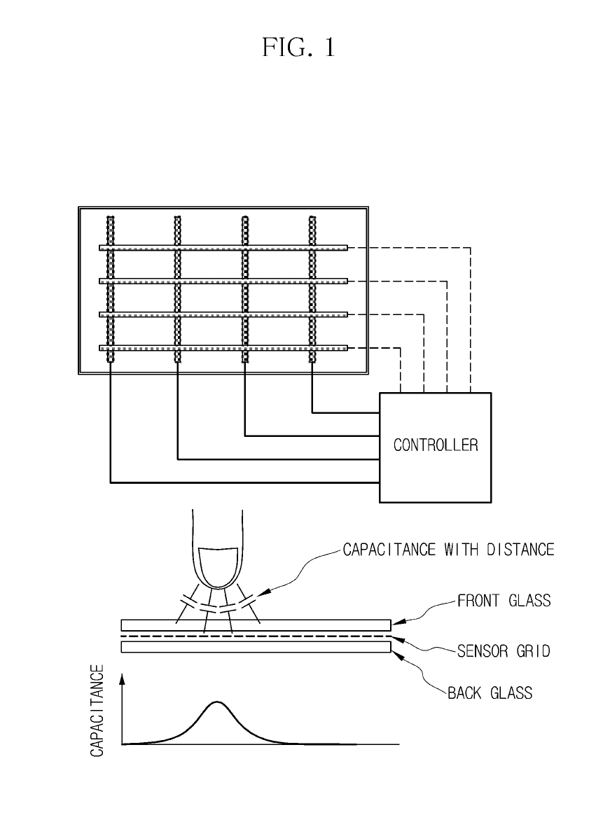

FIG. 2 is a diagram of a general touchscreen with a plurality of channels and patterns.

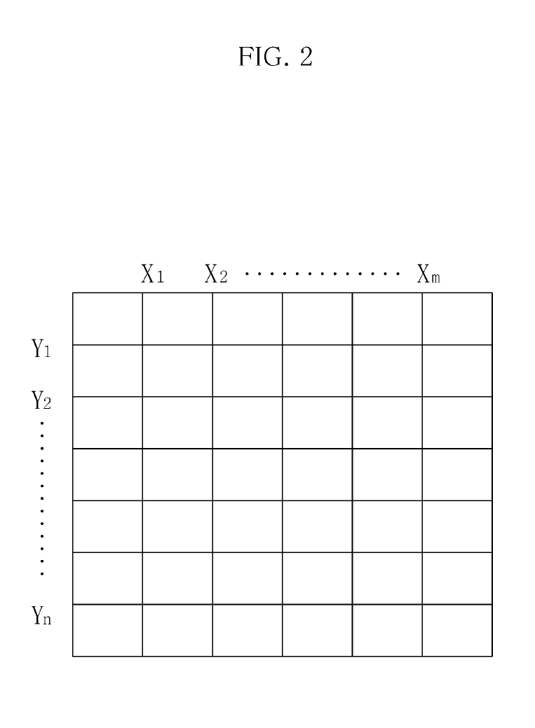

FIG. 3 is a diagram illustrating a group sensing operation according to an exemplary embodiment of the present invention.

FIG. 4 is a diagram illustrating a touch point sensing operation according to an exemplary embodiment of the present invention.

FIG. 5 is a diagram illustrating a first threshold value used for a group sensing operation and a second threshold value used for a touch point sensing operation according to an exemplary embodiment of the present invention.

FIG. 6 is a diagram illustrating a pattern of a touch panel according to an exemplary embodiment of the present invention.

FIG. 7 is a diagram schematically illustrating the pattern of FIG. 6.

FIG. 8 is a diagram illustrating a configuration of a Flexible Printed Circuit Board (FPCB) of a touch panel according to an exemplary embodiment of the present invention.

FIG. 9 is a diagram illustrating a configuration of inter-layer connections in a FPCB according to an exemplary embodiment of the present invention.

FIG. 10 is a diagram illustrating a configuration of a terminal having a capacitive type touchscreen according to an exemplary embodiment of the present invention.

FIG. 11 is a flowchart illustrating a touch position detecting method according to an exemplary embodiment of the present invention.

FIG. 12 is a diagram illustrating a touch point sensing operation when a touch input unit contacts the touch panel according to an exemplary embodiment of the present invention.

FIG. 13 is a diagram illustrating channels of which capacitance values exceed a first threshold value as a touch input unit approaches a touch panel according to an exemplary embodiment of the present invention.

FIG. 14 is a diagram illustrating channels of which capacitance values exceed a second threshold value as a touch input unit approaches a touch panel according to exemplary embodiment of the invention.

FIG. 15 is a diagram illustrating a touch point sensing operation when a touch input unit is dragged in a state of contacting a touch panel according to an exemplary embodiment of the present invention.

FIG. 16 is a diagram illustrating a touch point sensing operation when a touch input unit is separated from its contact with a touch panel according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

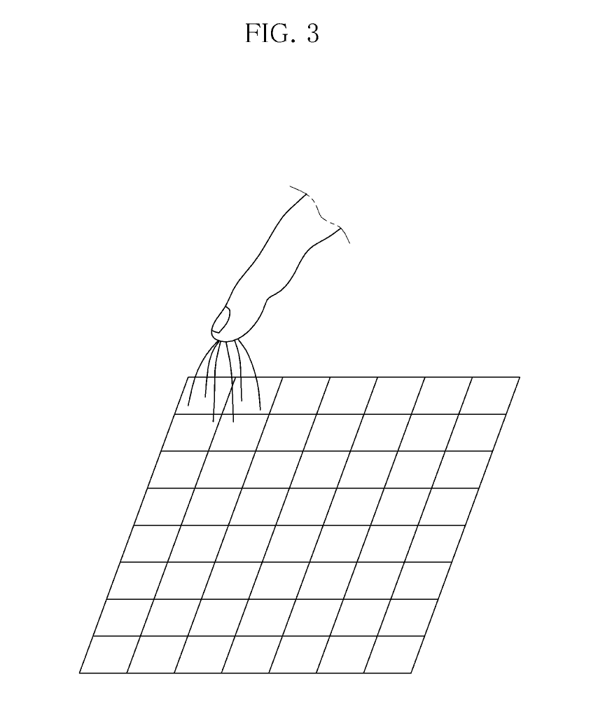

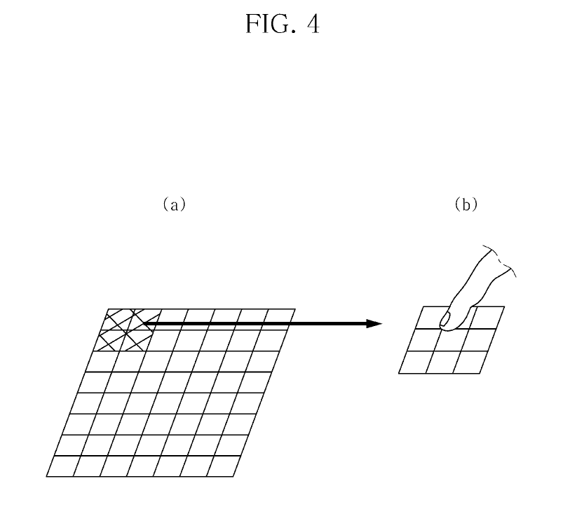

FIG. 3 is a diagram illustrating a group sensing operation according to an exemplary embodiment of the present invention. FIG. 4 is a diagram illustrating a touch point sensing operation according to an exemplary embodiment of the present invention.

As illustrated in FIG. 3 and FIG. 4, a terminal senses a touch point through two operations, including the group sensing operation (FIG. 3), and the touch point sensing operation (FIG. 4).

A capacitance value may be changed as a touch input from a conductive material, such as a finger or an electrostatic touch panel, approaches the touch panel without contacting the touch panel. More specifically, when the touch input approaches the touch panel including multiple channels, a capacitance value corresponding to portions of one or more channels may increase. Further, at least one of the channels may include multiple patterns, including an original pattern and a duplicate pattern. The patterns may correspond to at least one of the channels and operate similar to a channel. In an example, the original pattern and the corresponding channel may be located in the same position, and the duplicate pattern may be located between patterns of the channel and a different or adjacent channel.

More specifically, referring to FIG. 3, an operation of sensing an approach of a touch input by a group of channel portions or pattern portions, which may be referred to as a group sensing operation, is illustrated. Further, referring to FIG. 4, an operation of sensing a touch point on the touch panel using a capacitance value, which may be changed as the touch input unit contacts the touch panel, may be referred to as the touch point sensing operation.

More specifically, referring to FIG. 3, the group sensing operation of sensing a group of channel portions or pattern portions that may have their capacitance values increase as the touch input unit approaches the touch panel may be performed by using a proximity touch operation. More specifically, the group sensing operation may sense the group of channel portions or pattern portions when the touch input unit approaches the touch panel to within a reference proximity. Thereafter, in a state where the group of channel portions or pattern portions is sensed as illustrated in (a) of FIG. 4, the touch point sensing operation may be performed by touching a specific point on the touch panel as illustrated in (b) of FIG. 4. Although sensing operation is described with respect to sensing a group of channel portions or pattern portions, aspects of the invention are not limited thereto, such that the sensing operation may also be performed to sense a single channel portion or a pattern portion to provide a single set of sensing coordinates.

The terminal according to exemplary embodiments may detect a point touched by a user, which may correspond to a portion of a pattern or an intersection of a pattern, by combining the channel portions or the pattern portions detected by the group sensing operation and the touch point sensing operation.

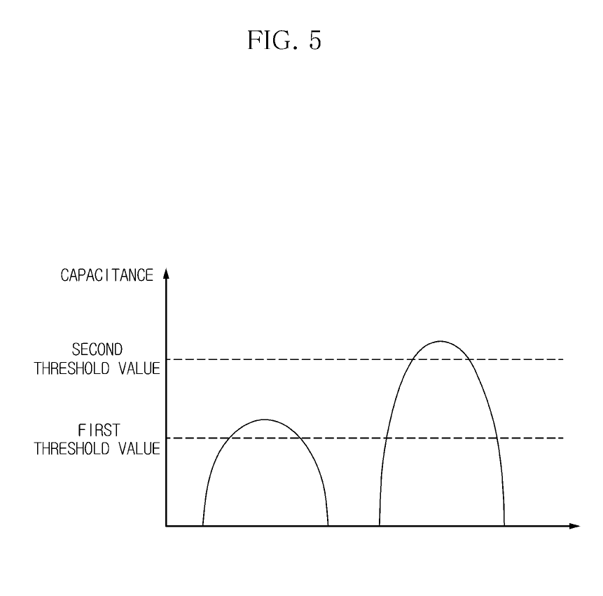

FIG. 5 is a diagram illustrating a first threshold value used for a group sensing operation and a second threshold value used for a touch point sensing operation according to an exemplary embodiment of the present invention.

In FIG. 5, the first threshold value may refer to a threshold value used for the group sensing operation, and the second threshold value may refer to a threshold value used for the touch point sensing operation. More specifically, if capacitance of a channel portion or a pattern portion is above the first threshold value, then the respective channel may be sensed by the group sensing operation. If capacitance of a point within the group of channel portions or pattern portions is above the second threshold value, the point may be sensed as the touch point by the touch point sensing operation.

Typically, a capacitance value may be increased as the touch input unit approaches the touch panel. More specifically, when the touch input unit is distant from the touch panel by at least a reference distance, the capacitance value may be at a low level. As the touch input unit approaches the touch panel within the reference distance, the capacitance value may be increased, and the capacitance value above the second reference threshold value may be detected when a contact is made on the touch panel by the touch input unit.

The first threshold value may refer to a capacitance value, which may be a reference value to sense a plurality of channels or patterns in each of the X and Y axes and may be a threshold value used for the group sensing operation. More specifically, the first threshold value may refer to a threshold value for sensing an approach of the touch input unit within a reference distance to the touch panel.

The first threshold value may be set according to the number of channels or patterns that may be detected by the group sensing operation, which may group sensing coordinates and physical intervals that may be present between the patterns. Group sensing coordinates may refer to points of intersection between portions of channels or patterns that detects a capacitance value above the first threshold value. When the number of channels or patterns to be detected by the group sensing operation is increased, the first threshold value may be decreased, such that the touch input unit may be sensed at a greater distance. When the number of channels or patterns to be detected in the group sensing operation is decreased, the first threshold value may be increased, such that the touch input unit may be sensed when it is at a closer distance. In addition, when the physical interval between the patterns is narrower than a reference distance, the first threshold value may be decreased. When the physical interval between the patterns is wider than a reference distance, the first threshold value may be increased. Although sensing coordinates may be described with respect to a group of sensing coordinates, aspects of the invention are not limited thereto, such that the sensing coordinates may refer to a single set of sensing coordinates. The sensing coordinates corresponding to a point or points of intersections between portions of channels or patterns that detects a capacitance value above the first threshold value may also be referred to as first sensing coordinates.

The second threshold value may refer to a capacitance value, which may be a reference value for sensing a channel portion or a pattern portion or an intersection between channel portions or pattern portions among the plurality of channels on the touch panel. The second threshold value may also refer to a threshold value used to sense a touch point. The second threshold value may be set to sense a capacitance value that may occur when the touch input unit contacts the touch panel. Therefore, the second threshold value may be higher than the first threshold value. In addition, the first threshold value and the second threshold value may have reference offsets.

The group sensing operation and the touch point sensing operation may be performed on the basis of the first threshold value and the second threshold value set as described above.

More specifically, when the touch input unit approaches the touch panel, the capacitance values of the pattern or channel portions that the touch input unit approaches may be changed. When the pattern or channel portions of which the capacitance values are changed to be greater than or equal to the first threshold value, the respective group of patterns or channel portions may be determined to be sensed.

As described above, the number of patterns or channels located along the X axis and the Y axis for group sensing operation may be determined according to the first threshold value. In an example, the numbers of patterns or channels used for group sensing operation may be 2 or 3 according to the first threshold value. As the threshold value is increased, the number of patterns or channels used for group sensing operation may be reduced, and as the threshold value is reduced, the number of patterns used for group sensing operation may be increased.

When the touch input unit contacts the touch panel, the capacitance value of the pattern or channel portion where the contact is made may be changed to at least the second threshold value. In addition, the pattern or channel portion of which the capacitance value is changed to at least the second threshold value may be sensed to sense a touch point.

As described above, when the capacitance value changes to at least the first threshold value, the group sensing operation may be performed, and when the capacitance value changes to at least the second threshold value, the touch point sensing operation may be performed. Accordingly, with respect to the group sensing operation, when the capacitance value of a pattern or channel portion is between the first threshold value and the second threshold value, the respective pattern or channel portion may be recognized as a sensed pattern or channel portion.

When a capacitance value of at least the first threshold value is detected for a pattern or channel portion, a determination of whether the detected capacitance value is greater than or equal to the second threshold value is made. Further, when the detected capacitance value of a pattern or channel portion is smaller than the second threshold value, the group sensing operation may be performed. When the detected capacitance value of a pattern or channel portion has at least the second threshold value, the touch point sensing operation may be performed. The group sensing operation and the touch point sensing operation may be determined within the margin of error using offsets of the first threshold value and the second threshold value.

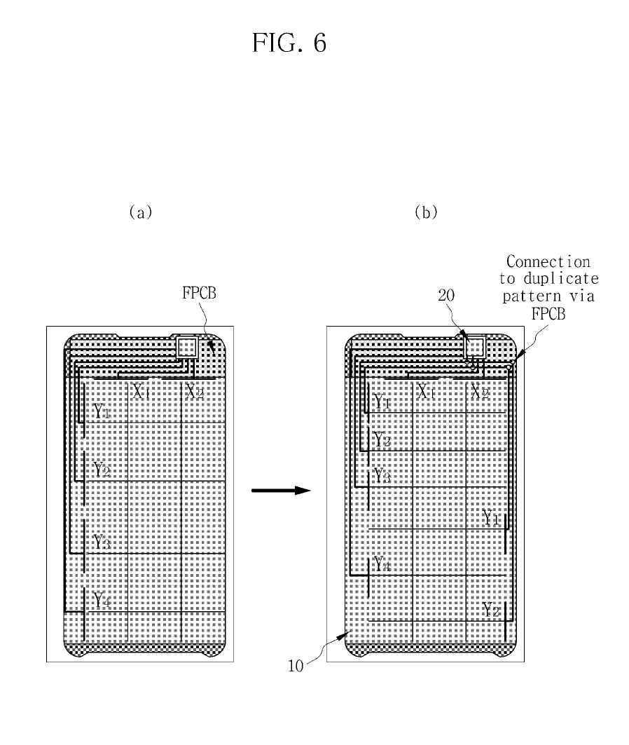

FIG. 6 is a diagram illustrating a pattern of the touch panel according to an exemplary embodiment of the present invention.

When the touch panel 10 is configured using a controller 20 having m X-axis channels and n Y-axis channels, patterns for one or more channels may be configured to be duplicated in the touch panel 10. The controller 20 may be a touch integrated circuit (IC).

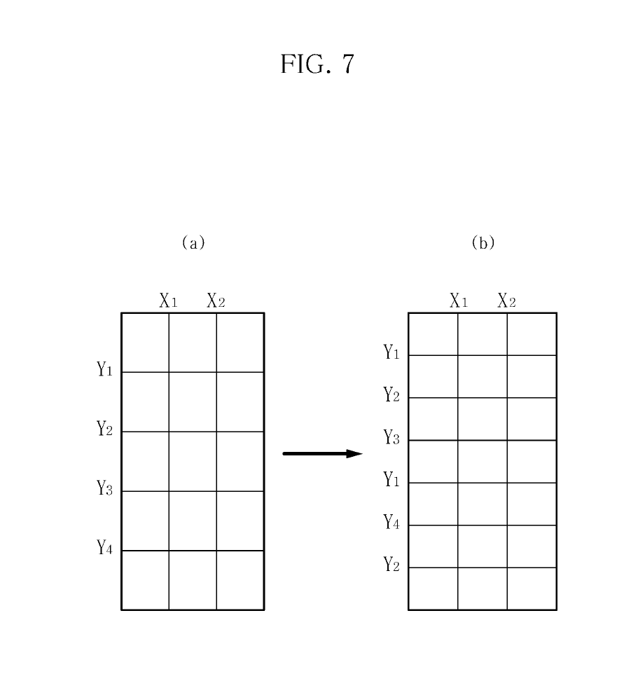

Referring to (a) of FIG. 6 and (a) of FIG. 7, the touch panel 10 is configured using the controller 20 to have two X-axis channels (X₁, X₂) and four Y-axis channels (Y₁, Y₂, Y₃, Y₄) to provide 2×4 channels or patterns having specific coordinates. Coordinates may refer to a point of intersection between two or more channels or patterns.

However, referring to (b) of FIG. 6, some of the channels, for example, patterns of the Y₁ and Y₂ channels in the Y axis may be arranged to be duplicated in the touch panel 10. By configuring the arrangement of the Y-axis channels to include the duplicated patterns of the Y₁ and Y₂ channels, a 2×6 channels or patterns having specific coordinates may be recognized as illustrated in (b) of FIG. 7. The arrangement including the duplicated patterns of the Y₁ and Y₂ channels may provide four more channels that may be recognized than the configuration of (a) of FIG. 6 or (a) of FIG. 7 without requiring additional inputs to or channels of the controller 20.

While duplication of patterns of the Y₁ and Y₂ channels in the Y axis are described above, aspects of the invention are not limited thereto, such that patterns of additional channels in the Y axis may be duplicated. Further, patterns of channels in the X axis may also be duplicated in various numbers.

As described above, when the patterns of channels are arranged to be duplicated, each of the patterns arranged to be duplicated may be configured to have a different channel value from the adjacent pattern. This may be true regardless of direction, including a vertical direction and a horizontal direction. More specifically, when the pattern for each channel to be duplicated is arranged, the pattern may be arranged so as not to be physically adjacent to the pattern of the same channel. For example, when the pattern of the Y₁ channel is arranged to be duplicated as shown in (b) of FIG. 6 and in (b) of FIG. 7, the duplicated pattern of the Y₁ channel may be arranged not to be adjacent to the original pattern of the Y₁ channel regardless of direction, whether vertical or horizontal. In addition, when the pattern of the Y₂ channel is arranged to be duplicated, the duplicated pattern of the Y₂ channel may be arranged not to be adjacent to the original pattern of the Y₂ channel regardless of direction.

When the patterns of the same channel are arranged adjacent to each other (e.g., duplicated Y₂ adjacent to original Y₂), even if two patterns output electrical signals according to changes in the capacitance value, only a single signal may be applied to the controller 20. As described above, during the group sensing operation, a plurality of adjacent channels where capacitance values of portions of the respective channels change to at least the first threshold value as the touch input unit approaches are detected. However, if multiple patterns of the same channel are adjacent to each other, the position of the touch input approach detected by the group sensing may not be recognized with a reference level of accuracy. Accordingly, the patterns of the same channel may not be arranged adjacently to each other.

In addition, a set of patterns of channels that are arranged adjacently once may not be arranged adjacently again. For example, a set of channels including Y₁ may be arranged next to another set including a duplicate Y₁ once. A set of channels or patterns that are adjacent regardless of directionality may be uniquely configured in the entire touch panel. For example, the Y₁ channel in (b) of FIG. 6 and in (b) of FIG. 7 may have pattern arrangements including Y₁Y₂ and Y₃Y₁Y₄, and the number of the set of adjacent channels may include two sets over the entire touch panel regardless of direction. Therefore, a pattern set configuration, such as Y₂Y₁ or Y₄Y₁Y₃ may not be added to the arrangement of (b) of FIG. 6 or (b) of FIG. 7.

The avoidance of having multiple adjacent sets of patterns may be to prevent two or more groups of pattern portions being sensed simultaneously when groups of pattern portions are sensed using the changes in the capacitance values as the touch input unit approaches the touch panel. More specifically, the controller 20 may not recognize the directionality of the channels detected through group sensing operation and may detect only the values of the channel portions. For example, when the channel values detected by the controller 20 during group sensing operation are arranged as Y₁Y₂ and when the channel values are arranged as Y₂Y₁, the controller 20 may recognize that changes in the capacitance of at least the first threshold occur in the Y₁ and Y₂ channels or (Y₁, Y₂) group without regard to directionality. However, aspects of the invention are not limited thereto, such that if the controller 20 senses the directionality of each channel, such as vertical and horizontal arrangement relationships, the vertical or horizontal arrangement relationship between adjacent patterns may be changed to arrange the patterns to be additionally duplicated.

When the patterns of one or more channels are arranged to be duplicated, the pattern may be configured through a Flexible Printed Circuit Board (FPCB) of the touch panel 10.

As illustrated in (b) of FIG. 6, the Y₁ pattern arranged to be duplicated may be connected to the Y₁ channel of the controller 20 through the FPCB.

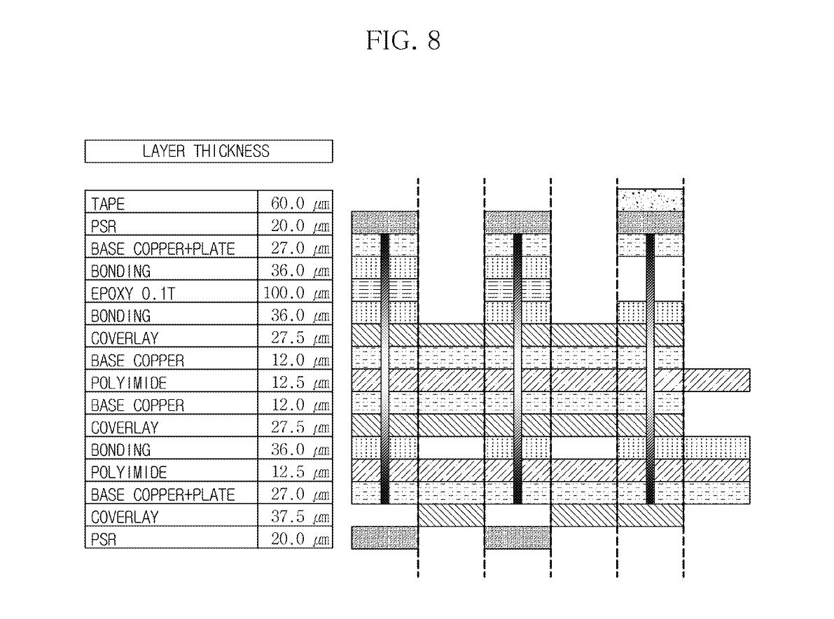

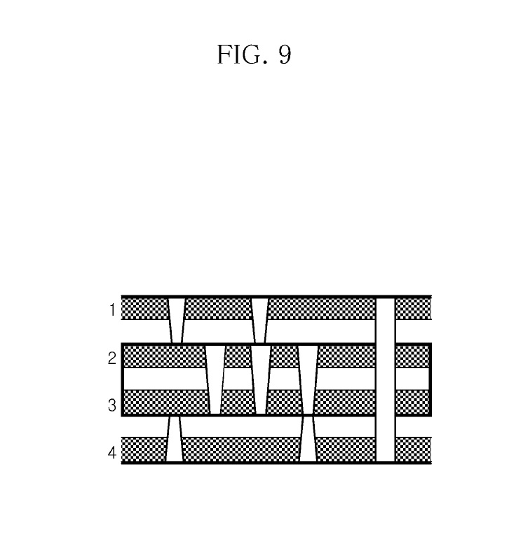

The FPCB of the touch panel 10 may be configured as multiple layers as illustrated in FIG. 8, and interlayer patterns may be connected as illustrated in FIG. 9.

A reference number (Txy) of patterns that may be implemented on the touch panel 10 by arranging the duplicated patterns of one or more channels in the touch panel 10 may be obtained through Mathematical Expression 1, Mathematical Expression 2, Mathematical Expression 3, Mathematical Expression 4, and Mathematical Expression 5.

$$[ Mathematical Expression 1 ]$$

$${X}_{b} = {mCr}_{1} = \frac{m !}{{r}_{1} ! ( m - {r}_{1} ) !}$$

Mathematical Expression 1 may refer to an expression representing a reference or maximum number of times a pattern of a channel that is to be duplicated may be subjected to group sensing operation in the X direction. In Mathematical Expression 1, m may refer to the number of channels used in the X axis, r₁ may refer to the number of patterns in the X axis used for group sensing operation. In addition, m may be determined according to the controller 20 in use, and r₁ may be determined according to initial factors determining the number of patterns in the X axis used for the group sensing operation.

$$[ Mathematical Expression 2 ]$$

$${Y}_{b} = {nCr}_{2} = \frac{n !}{{r}_{2} ! ( n - {r}_{2} ) !}$$

Mathematical Expression 2 may refer to an expression representing a reference number of times that a target channel that is to be duplicated may be subjected to the group sensing operation in the Y direction. In Mathematical Expression 2, n may refer to the number of channels used in the Y axis, and r₂ may refer to the number of patterns in the Y axis used for group sensing operation. In addition, n may be determined according to the controller 20 in use, and r₂ may be determined according to initial factors determining the number of patterns in the Y axis used for the group sensing operation.

X₁=X_{b}+(r₁−1) [Mathematical Expression 3]

Mathematical Expression 3 may refer to an expression representing the number of patterns configured in the X axis.

Y₁=Y_{b}+(r₂−1) [Mathematical Expression 4]

Mathematical Expression 4 may refer to an expression representing the number of patterns configured in the Y axis.

T_{xy}=X₁×Y₁ [Mathematical Expression 5]

Mathematical Expression 5 may refer to an expression representing the reference or maximum number (Txy) of patterns that may be implemented on the touch panel 10.

For example, when the controller 20 is configured to have m value of 14 and n value of 16, the r₁ number of patterns in the X axis used for group sensing operation may be 2, and the r₂ number of patterns in the Y axis used for group sensing operation is 2, the X_{b} number of times that the duplicated patterns may be subjected to group sensing operation in the X axis may be 91 according to Mathematical Expression 1, the Y_{b} number of times that the duplicated patterns may be subjected to group sensing in the Y axis may be 120 according to Mathematical Expression 2. The X_{b} may refer to a reference number or a maximum number of times that the duplicated channels may be subjected to group sensing operation in the X axis, and the Y_{b} may refer to a reference number or a maximum number of times that the duplicated channels may be subjected to group sensing operation in the Y axis. Further, the X₁ number of patterns configured in the X axis may be 92 according to Mathematical Expression 3, the Y₁ number of patterns configured in the Y axis may be 121 according to Mathematical Expression 4, and the Txy number of patterns that may be implemented on the touch panel 10 may be 11,132 according to Mathematical Expression 5. The Txy may refer to a reference or maximum number of patterns that may be implemented on the touch panel 10. More specifically, a reference or maximum touch resolution of 11,132 channels may be provided.

As described above, when the touch panel 10 is configured by using the controller 20 to have m value of 14 and n value of 16 according to the related art, a touch panel having a resolution of 224 (i.e., 14×16=224) patterns or coordinates may be configured based on a 1:1 mapping between the channels and the patterns. However, when the patterns are configured according to exemplary embodiments of the present invention, a touch panel having a reference resolution of 11,132 patterns or coordinates may be configured based on a 1: N mapping between the channels and the patterns.

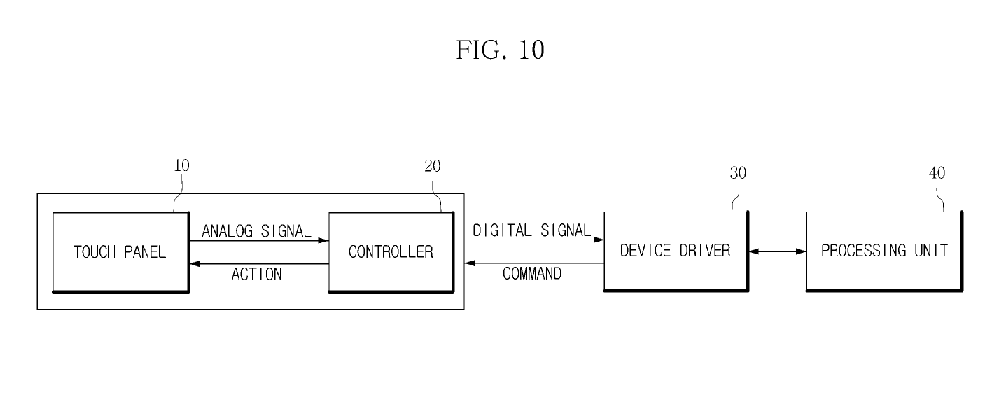

FIG. 10 is a diagram illustrating a configuration of a terminal having a capacitive type touchscreen according to an exemplary embodiment of the present invention.

In FIG. 10, the touch panel 10 may sense a capacitance generated by an approach or contact of the touch input unit, such as a finger of the user or an electrostatic type touch panel. The touch panel 10 may generate an analog coordinate signal in response to the sensed capacitance, and transmits the signal to the controller 20 (e.g., the touch IC).

The touch panel 10 may not be implemented with the same number of patterns and channels of the controller 20 provided by forming a single pattern for a single channel. According to exemplary embodiments of the present invention, the patterns may be arranged to be allocated to each channel, and the patterns allocated to one or more channels may be arranged to be duplicated. More specifically, a plurality of patterns may be formed for one or more channels, such that a larger number of patterns than the number of channels of the controller 20 may be implemented.

For example, when the touch panel 10 is configured by using the controller 20 having m X-axis channels and n Y-axis channels, according to the related art, m patterns may be formed in the X axis of the touch panel 10, and n patterns may be formed in the Y axis, such that the touch panel 10 having m+n patterns may be configured. However, according exemplary embodiments of the invention, m+a patterns may be formed in the X axis, n+b patterns may be formed in the Y axis, such that the touch panel 10 having (m+a)+(n+b) patterns may be configured. Here, a value may refer to the number of patterns that may be duplicated in the X axis, and b value may refer to the number of patterns that may be duplicated in the Y axis. Both a and b may be an integer having a value greater than or equal to 0.

The controller 20 having m Y-axis channels and n Y-axis channels may convert an analog coordinate signal transmitted from the touch panel 10 through one or more channels into a digital coordinate signal, and transmit the digital coordinate signal to a device driver 30.

In addition, the controller 20 may determine the validity of an input value transmitted from the touch panel 10 on the basis of set threshold values (i.e., the first threshold value and the second threshold value), and may transmit a capacitance value corresponding to the coordinate signal transmitted from the touch panel 10 through one or more channels to the device driver 30.

The device driver 30 transmits the coordinate signal and the capacitance value for the channel where a touch input is sensed to a processing unit 40.

The processing unit 40 may sense a group of channel portions on the basis of the set first threshold value in the group sensing operation. Further, the processing unit 40 may sense a touch point on the basis of the set second threshold value in the touch point sensing operation. More specifically, the group sensing operation may be performed on the coordinate signals having capacitance values between the first threshold value and the second threshold value among the coordinate signals transmitted through the device driver 30. The touch point sensing operation may be performed on the coordinate signals having capacitance values greater than or equal to the second threshold value.

By combining the coordinates detected in the group sensing operation and the touch point sensing operation, the processing unit 40 may detect touch input coordinates with a reference level of accuracy.

The processing unit 40 may include, without limitation, a group sensing unit to process the group sensing operation for the coordinate values of the detected channel portions or pattern portions, a touch point sensing unit to process the touch point sensing operation, and a touch position detection unit to detect touch input coordinates with reference accuracy by combining the processing results of the group sensing unit and the touch point sensing unit.

According to exemplary embodiments of the present invention, when the controller 20 having the m X-axis channels and the n Y-axis channels is used, a plurality of patterns may be formed for a single channel, and thus a larger number of patterns than the number of channels provided in the controller 20 may be formed in the touch panel 10.

Accordingly, the number of channels of the controller 20 and the number of patterns formed in the touch panel 10 may not equal to each other, such that a touch position of the user may not be detected with a reference level of accuracy using existing pattern information corresponding to the number of channels of the controller 20.

In order to alleviate this problem, the controller 40 may store information of newly implemented pattern information, as well as the existing pattern information, and detect the touch position of the user with reference accuracy using the aggregated pattern information.

For example, when the controller 20 having m X-axis channels and n Y-axis channels is used, m+a patterns may be formed in the X axis of the touch panel 10, and n+b patterns may be formed in the X axis, the processing unit 40 may store pattern information configured of (m+a)+(n+b) patterns.

Here, the processing unit 40 may store arrangement information on the patterns. More specifically, as illustrated in (b) of FIG. 7, when the X-axis patterns are arranged in the order of X₁ and X₂, and the Y-axis patterns are arranged in the order of Y₁, Y₂, Y₃, Y₁, Y₄, and Y₂, arrangement information on the patterns may be stored.

The arrangement information may refer to information about the physical arrangement of one or more patterns implemented in the touch panel 10 and may use the channel value of the duplicated pattern. Further, referring to (b) of FIG. 7, the arrangement information may store information of Y₁, Y₂, Y₃, Y₁, Y₄, and Y₂ patterns with respect to the Y axis. In addition, the pattern information may assign identification information that may not be duplicated for one or more of the duplicated patterns, as new identification information assigned for the physical patterns implemented in the touch panel 10. For example, in (b) of FIG. 7, the pattern information may store identification information of Y′₁, Y′₂, Y′₃, Y′₄, Y′₅, and Y′₆ for the duplicated patterns. Furthermore, the arrangement information and the pattern information may be mapped to each other for storage.

Further, the arrangement information, which may refer to information associated with the physical arrangement of the patterns implemented in the touch panel 10, and the pattern information to which the identification information may be assigned to distinguish the duplicated patterns from the physical arrangement of the patterns implemented in the touch panel 10 may be stored in the processing unit 40 to detect the touch position of the user with reference accuracy using this information. The information may be stored using an additional storage unit (not shown) or stored within the display device.

The touch input coordinate values calculated by the processing unit 40 may be provided for the operations that may be performed for the upper layer, such as a platform or an application program, and a command may periodically be transmitted to the controller 20 to allow the touch panel 10 to maintain an operation with reference accuracy.

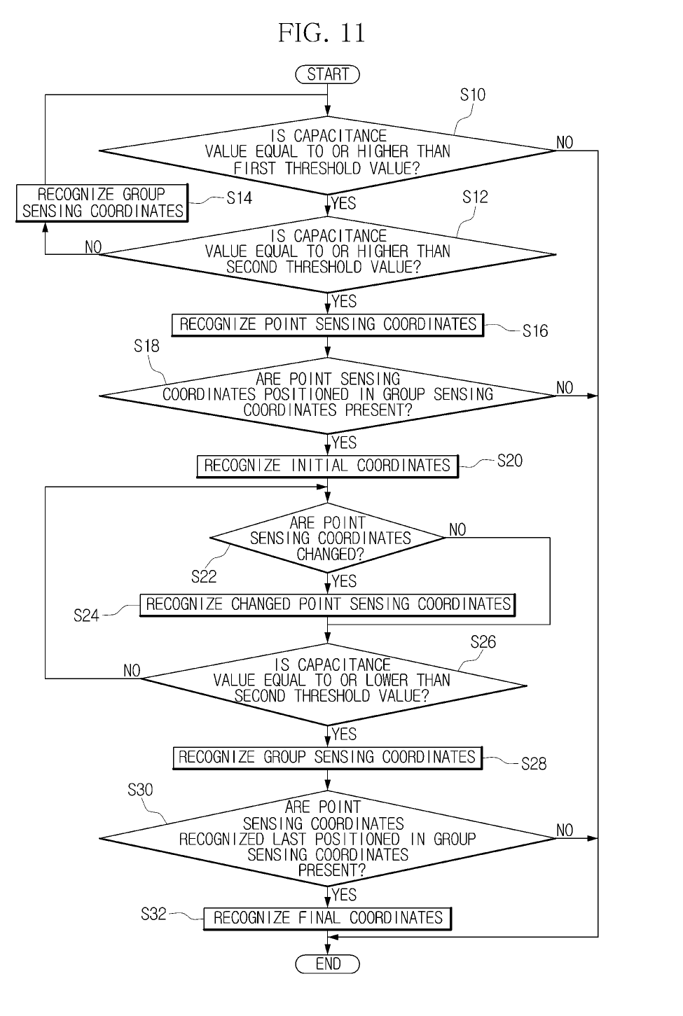

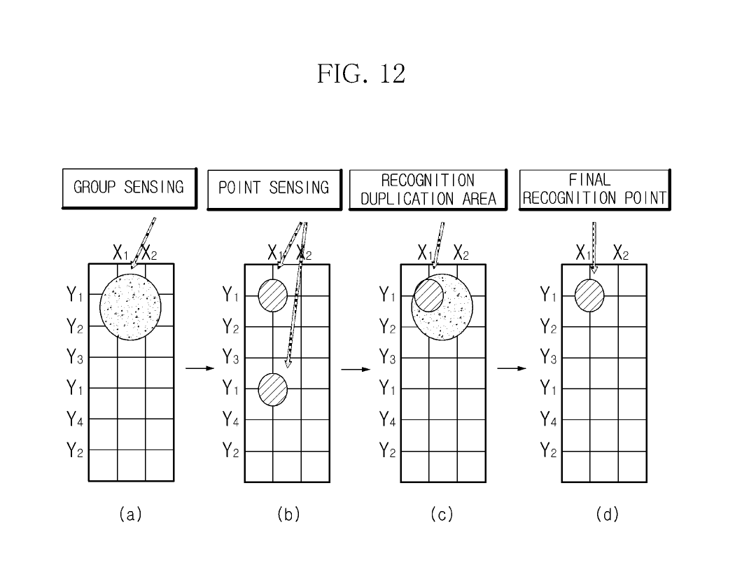

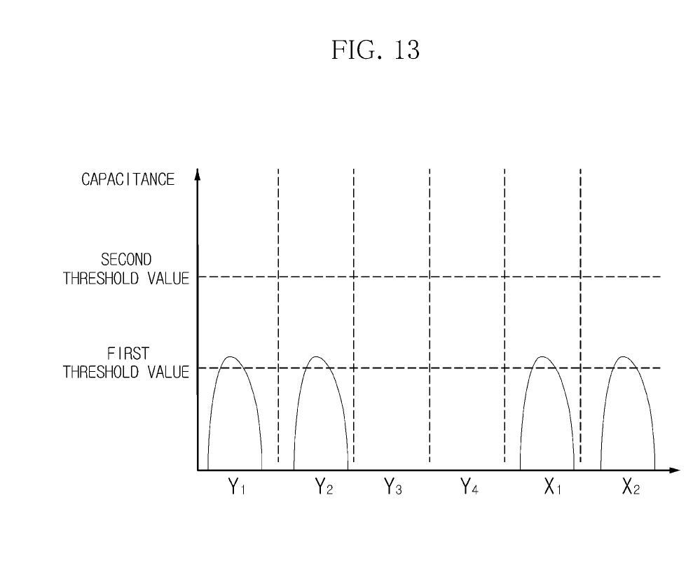

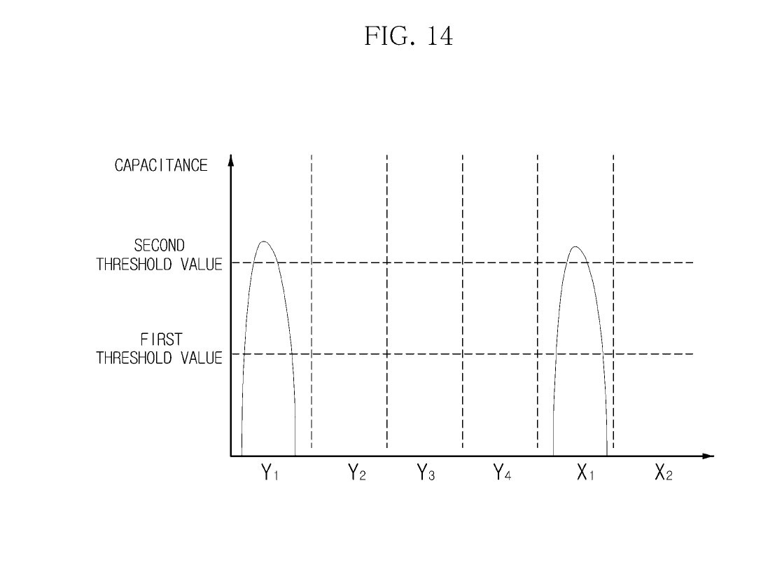

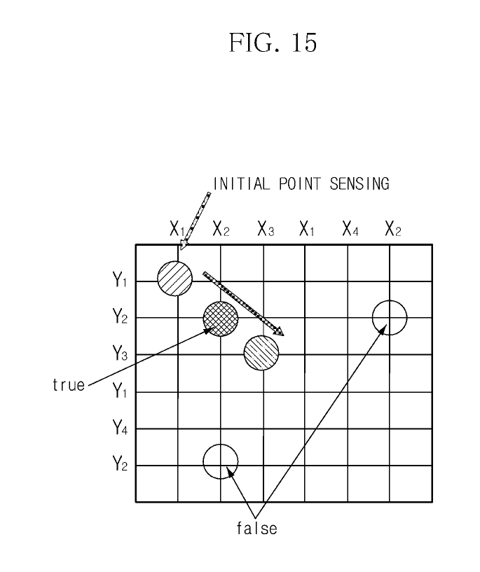

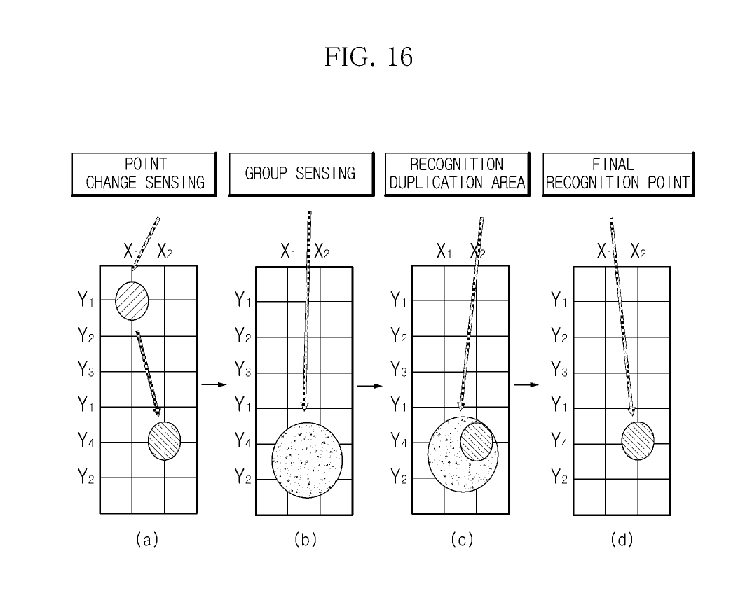

FIG. 11 is a flowchart illustrating a touch position detecting method according to an exemplary embodiment of the present invention. FIG. 12 is a diagram illustrating a touch point sensing operation when a touch input unit contacts a touch panel according to an exemplary embodiment of the present invention. FIG. 13 is a diagram illustrating channels of which capacitance values exceed a first threshold value as a touch input unit approaches a touch panel according to an exemplary embodiment of the present invention. FIG. 14 illustrates channels of which capacitance values exceed a second threshold value as a touch input unit approaches a touch panel according to exemplary embodiment of the invention. FIG. 15 is a diagram illustrating a touch point sensing operation when a touch input unit is dragged in a state of contacting a touch panel according to an exemplary embodiment of the present invention. FIG. 16 is a diagram illustrating a touch point sensing operation when a touch input unit is separated from its contact with a touch panel according to an exemplary embodiment of the present invention.

When the touch input unit approaches the touch panel 10 to contact the touch panel 10, the capacitance values of pattern portions that the touch input unit approaches towards may be changed, and the changed capacitance values may be applied to the controller 20 of the touchscreen through the channel connected to each of the patterns.

The controller 20 may transmit at least one of coordinate values or signals of the channel portions or pattern portions having capacitance values of at least the first threshold value, the capacitance values being applied through the channel portions or the pattern portions as the touch input unit approaches the touch panel 10, and the applied capacitance values of the corresponding channel portions or pattern portions, to the device driver 30. The device driver 30 may transmit the capacitance values to the processing unit 40 again. When a capacitance value smaller than the first threshold value is applied from the touch panel 10, the controller 20 may determine that an effective touch is not generated in the corresponding channel portion or pattern portion (e.g., noise) and may ignore the capacitance value.

In operation S10, the processing unit 40 may determines whether the capacitance value applied to the corresponding channel portion or pattern portion for the coordinate value or coordinate signal of one or more of the channel portions or the pattern portions transmitted through the device driver 30 is greater than or equal to the first threshold value. If the processing unit 40 determines that the capacitance value applied through each of the channel portion or the pattern portion is determined to be less than the first threshold value, the processing unit 40 ignores the detected capacitance value. Although not illustrated, if the processing unit 40 determines that the capacitance value applied through each of the channel portion or the pattern portion is determined to be greater than or equal to the first threshold value, the processing unit 40 may recognize group sensing coordinates for the channel portions or the pattern portions corresponding to the respective capacitance value.

If r₁ number of the patterns in the X axis and r₂ number of patterns in the Y axis in which the first threshold value is used for group sensing operations are respectively set to 2, the capacitance values that exceed the first threshold value may be simultaneously applied to the controller 20 through the Y₁ and Y₂ channels in the Y axis and through the X₁ and X₂ channels in the X axis as the touch input unit approaches the touch panel 10, as illustrated in FIG. 13.

In operation S12, if the capacitance value applied through each of the channel portion or the pattern portion is determined to be greater than or equal to the first threshold value, the processing unit 40 may determine whether the capacitance value applied through each of the channel portion or the pattern portion is greater than or equal to the second threshold value.

In operation S14, if the capacitance value applied through each of the channel portions or pattern portions is determined to be less than the second threshold value but greater than or equal to the first threshold value, the channel value corresponding to the applied capacitance value may be applied to the group sensing unit of the processing unit 40, and the group sensing unit recognizes group sensing coordinates or group of sensed channel portions or pattern portions using the channel value corresponding to the applied capacitance. Further, reference margins of error may be applied to the first threshold value and the second threshold value. Although the group sensing unit is described as recognizing group sensing coordinates for a group of sensed channel portions or pattern portions, aspects of the invention are not limited thereto, such that the group sensing unit may recognize group sensing coordinates for a single channel portion or pattern portion.

For example, when the capacitance values are changed in the X₁ and X₂ channels in the X axis and the Y₁ and Y₂ channels in the Y axis to have values between the first threshold value and the second threshold value when the touch input unit approaches the touch panel 10 as illustrated in FIG. 13, the group sensing unit of the processing unit 40 may recognize X₁Y₁, X₂Y₁, X₁Y₂, and X₂Y₂ as group sensing coordinates or group of sensed channel portions or pattern portions as illustrated in (a) of FIG. 12.

In an example, if the number of patterns in the X axis and the number of patterns in the Y axis used for the group sensing operation are respectively set to 2 in operation S14, the number of channels or patterns in the X axis of which the capacitances are changed to at least the first threshold may be two or more, and the number of channels or patterns in the Y axis of which the capacitances are changed to at least the first threshold may be two or more for performing a group sensing operation.

In operation S16, when an additional change in the capacitance value occurs after the group sensing operation and the capacitance value is changed to at least the second threshold value in operation S12, the channel value of which the capacitance is changed to at least the second threshold value is applied to the touch point sensing unit of the processing unit 40. Further, the touch point sensing unit may recognize point sensing coordinates using the channel value of which the capacitance is changed to at least the second threshold value. Point sensing coordinates may refer to a point of intersection between portions of channels or patterns that detects a capacitance value above the second threshold value. The sensing coordinates corresponding to a point or points of intersections between portions of channels or patterns that detects a capacitance value above the second threshold value may also be referred to as second sensing coordinates.

When the capacitance values changed in the X₁ channel in the X axis and the Y₁ channel in the Y axis exceed the second threshold value as illustrated in FIG. 14 as the touch input unit contacts the touch panel 10 in S16, point sensing coordinates (X₁,Y₁) may be present as illustrated in the portion (b) of FIG. 12.

In operation S18, to determine a valid value, the touch position detection unit of the controller 40 may check to determine whether point sensing coordinates positioned within the group sensing coordinates recognized through operation S14 are present.

When the point sensing coordinates positioned within the group sensing coordinates recognized through operation S14 are present, as illustrated in the portion (c) of FIG. 12, the touch position detection unit may determine that only the point sensing coordinates positioned within the group sensing coordinates recognized through S14 among other sensed coordinates having capacitance of at least second threshold value as a valid value. More specifically, in operation S20, as illustrated in the portion (d) of FIG. 12, the point sensing coordinates positioned within the group sensing coordinates recognized through operation S14 may be recognized as initial coordinates, and point sensing coordinates that are not positioned in the group sensing coordinates are determined as invalid sensing coordinates. However, aspects of the invention are not limited thereto, such that point sensing coordinates that are not positioned in the group sensing coordinates or group of sensed channel portions or pattern portions may be determined to be valid sensing coordinates if the point sensing coordinates correspond to capacitance value above the second threshold value.

As such, in order to detect valid point sensing coordinates from a plurality of point sensing coordinates, the arrangement information and the pattern information may be applied. For example, in the pattern configuration as illustrated in FIG. 12, original patterns corresponding to channels along the X axis may be configured to have identification information of X₁ and X₂ and the pattern information of duplicated patterns along the X axis may be configured to have identification information of X′₁ and X′₂. Original patterns corresponding to channels along the Y axis may be configured to have identification information of Y₁, Y₂, Y₃, Y₁, Y₄, and Y₂ and the pattern information of duplicated patterns along the Y axis may be configured to have identification information of Y′₁, Y′₂, Y′₃, Y′₄, Y′₅, and Y′₆ for 1:1 mapping. Accordingly, the coordinates X₁Y₁ in the arrangement information detected through operation S20 may be converted into the coordinates X′₁Y′₁ in the pattern information to be transmitted, so that the terminal may recognize the point touched by the user with reference accuracy.

Further, as the determination result of operation S12, when the capacitance value is not changed to at least the second threshold value and the group sensing coordinates are changed, the group sensing coordinates initially recognized may be regarded as invalid coordinates, and the group sensing coordinates recognized last may be recognized as valid group sensing coordinates. The group sensing coordinates recognized last may be recognized as valid coordinates may be due, at least in part, to the touch input unit approaching the touch panel 10 in various directions and not only in a particular direction.

Further, after the initial coordinates are recognized, when the touch input unit is moved or dragged in the state of contacting the touch panel 10, the channel value that outputs a capacitance value of at least the second threshold value may be changed, and the point sensing coordinates may also be changed with the movement of the touch input unit.

In operation S22, a determination of whether the point sensing coordinates are changed, which may be based on the movement of the touch input unit contacting the touch panel 10, is made. If it is determined that the point sensing coordinates are changed, then, in operation S24, only the point sensing coordinates adjacent or within a reference proximity to the initial coordinates among the recognized point sensing coordinates may be recognized as valid point sensing coordinates. In addition, the point sensing coordinates that are not adjacent or outside of the reference proximity to the initial coordinates may be determined to be invalid coordinates.

For example, as illustrated in FIG. 15, when the touch input unit is moved in a first direction from X₁Y₁ coordinates, which may be initial coordinates, to X₂Y₂ coordinates and in a second direction from X₂Y₂ to X₃Y₃ in the state of contacting the touch panel 10, the channel values that output a capacitance value of at least the second threshold value may be changed from the X₁ channel in the X axis and the Y₁ channel in the Y axis, to the X₂ channel in the X axis and the Y₂ channel in the Y axis, and changed again from the X₂ channel in the X axis and the Y₂ channel in the Y axis, to the X₃ channel in the X axis and the Y₃ channel in the Y axis. Here, coordinate value of X₂Y₂, which may be the point sensing coordinates corresponding to the channel outputting the capacitance value of at least the second threshold value, are present at three points as illustrated in FIG. 15. Since the point sensing coordinates according to the movement of the touch input unit may not be present beyond a reference distance from the initial coordinates, only the point sensing coordinates within a reference proximity to the initial coordinates may be recognized as valid or true coordinates. Further, the point sensing coordinates that are outside of the reference proximity to the initial coordinates may be determined as invalid or false coordinates.

When the touch input unit contacting the touch panel 10 is separated from the touch panel 10, the capacitance value may be changed to be lower than the second threshold value. Further, as the touch input unit becomes more distant from the touch panel 10, the capacitance value may correspondingly be decreased.

In operation S26, when the capacitance value is changed to be lower than the second threshold value as the touch input unit contacting the touch panel 10 is separated from the touch panel 10, a channel value of which the capacitance is changed to a value between the first threshold value and the second threshold value is applied to the group sensing unit of the processing 40. In operation S28, the group sensing unit recognizes the group sensing coordinates using the channel value of which the capacitance is changed to the value between the first threshold value and the second threshold value.

In operation S30, a determination of whether the point sensing coordinates recognized last are positioned within the group sensing coordinates. If the sensing coordinates recognized last is determined to be present within the group sensing coordinates, the point sensing coordinates recognized last are recognized as the final or valid coordinates in operation S32.

For example, as illustrated in the portion (a) of FIG. 16, when the touch input unit contacting the touch panel 10 is moved from X₁Y₁ coordinates, which may be the initial coordinates, to X₂Y₄ coordinates and then separated from the touch panel 10, the group sensing unit may recognize X₁Y₄, X₂Y₄, X₁Y₂, and X₂Y₂ coordinates as the group sensing coordinates as illustrated in the portion (b) of FIG. 16, which may have capacitance values lower than the second threshold value and greater than or equal to the first threshold value. More specifically, the X₁ and X₂ channels in the X axis and the Y₄ and Y₂ channels in the Y axis may recognized as the group sensing coordinates.

When the point sensing coordinates X₂Y₄ recognized last are positioned within the group sensing coordinates recognized through S28 as illustrated in the portion (c) of FIG. 16, the point sensing coordinates X₂Y₄ may be recognized as the final coordinates as illustrated in the portion (d) of FIG. 16.

While the exemplary embodiments of the present invention disclose the touch input coordinates detected by the processing unit 40, aspects of the invention are not limited thereto. For example, the touch input coordinates may be implemented to be detected by the controller 20. More specifically, by altering the controller 20 to include the group sensing unit, the touch point sensing unit, and the touch position detection unit, the controller 20 may be enabled to detect touch input coordinates through group sensing operation and/or touch point sensing operation. Further, the touch input coordinate values calculated by the controller 20 may be transmitted to the device driver 30 to be provided for calculations performed for an upper layer, such as a platform or an application program, and a command to be executed may be periodically transmitted to the controller 20 to allow the touch panel 10 to maintain an accurate operation.

Further, the device driver 30 according to exemplary embodiments of the invention may include at least one of the group sensing unit, the touch point sensing unit, and the touch position detection unit. The configuration units may be separately included in at least one of the controller 20, the device driver 30, the processing unit 40, and the like.

More specifically, in order to detect a touch position through group sensing operation and/or touch point sensing operation, at least one of the controller 20, the device driver 30, and the processing unit 40 may be embodied in various forms.

In addition, according to exemplary embodiments of the present invention, the coordinate signal may be transmitted through each of the channels or patterns from the controller 20 and the capacitance value corresponding to the coordinate signal may be transmitted to the device driver 30 and the processing unit 40. However, the coordinate signal of the channel of which the capacitance is changed to a value between the first threshold value and the second threshold value and the coordinate signal of the channel of which the capacitance is changed to be greater than or equal to the second threshold value may be generated as different signals by the controller 20. For example, the coordinate signal of the channel or pattern of which the capacitance is changed to a value between the first threshold value and the second threshold value may be generated as a proximity touch signal, and the coordinate signal of the channel of which the capacitance is changed to be greater than or equal to the second threshold value may be generated as a direct touch signal.

The device driver 30 or the processing unit 40 may not determine again whether the capacitance value applied through each of the channels is a value between the first threshold value and the second threshold value or a value that is greater than or equal to the second threshold value. Further, the device driver 30 or the processing unit 40 may recognize group sensing coordinates using the proximity touch signal and recognize point sensing coordinates using the direct touch signal.

According to exemplary embodiments of the present invention, in a terminal having a capacitive type touchscreen, the touch panel may be configured by dividing the one or more channels and forming a plurality of patterns for the corresponding channel in a touch panel, so that a touch recognition area unit may be configured to be smaller than a conventional touch panel without an addition of an extra controller.

Accordingly, the touch precision of the touchscreen, which may be increased in size, may be maintained and/or enhanced using an existing controller.

In addition, the touchscreen may be implemented using the controller having a small number of channels. Therefore, the size of the controller may be reduced, such that the space to accommodate the controller in the terminal may be ensured, and manufacturing costs may be maintained or reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for detecting a touch input, comprising:
detecting a capacitance value on a pattern portion of a touch panel with respect to a touch input unit;
determining whether the capacitance value has at least a first threshold value;
recognizing first sensing coordinates corresponding to the capacitance value of the pattern portion if the capacitance value is determined to have at least the first threshold value;
determining whether the capacitance value of a portion of the pattern portion is above a second threshold value; and
recognizing second sensing coordinates if the capacitance value of the portion of the pattern portion has at least the second threshold value,
wherein the touch panel comprises a plurality of channels and at least one of the channels includes a first pattern and a second pattern.

2. The method of claim 1, wherein the first pattern corresponds to an original pattern of the channel and the second pattern corresponds to a duplicate pattern of the channel.

3. The method of claim 2, wherein a third pattern is disposed between the first pattern and the second pattern, the third pattern corresponding to another channel.

4. The method of claim 1, wherein the first threshold value is set according to a number of patterns having capacitance value of at least the first threshold value when the touch input is located within a reference distance from the touch panel.

5. The method of claim 1, wherein identification information of the corresponding channel is assigned to the first pattern and separate pattern information is generated and assigned to the second pattern.

6. The method of claim 1, wherein if the second sensing coordinates are positioned within the first sensing coordinates, the sensing coordinates are determined as initial coordinates.

7. The method of claim 6, further comprising:
detecting the first sensing coordinates are changed;
determining whether the changed first sensing coordinates are within a reference proximity of the initial coordinates; and
determining the changed first sensing coordinates as valid first sensing coordinates if the changed first sensing coordinates are determined to be within the reference proximity of the initial coordinates.

8. The method of claim 6, further comprising:
detecting the second sensing coordinates are changed;
determining whether the changed second sensing coordinates are within a reference proximity of the initial coordinates; and
determining the changed second sensing coordinates as final second sensing coordinates if the changed second sensing coordinates are determined to be within the reference proximity of the initial coordinates.

9. The method of claim 1, wherein the second threshold value is greater than the first threshold value.

10. A terminal, comprising:
a touch panel to detect a capacitance value associated with a touch input on a pattern portion, the touch panel comprising a plurality of channels and at least one of the channels includes a first pattern and a second pattern;
a controller to determine whether the capacitance value of the pattern portion has at least a first threshold value and to determine whether a capacitance value of a portion of the pattern portion has at least a second threshold value; and
a processing unit to recognize first sensing coordinates corresponding to the capacitance value of the pattern portion if the capacitance value is determined to have at least the first threshold value, and to recognize second sensing coordinates if the capacitance value of the portion of the pattern portion has at least the second threshold value.

11. The terminal of claim 10, wherein at least the second pattern is configured through a flexible printed circuit board (FPCB) of the touch panel.

12. The terminal of claim 10, wherein the first pattern corresponds to an original pattern of the channel and the second pattern corresponds to a duplicate pattern of the channel.

13. The terminal of claim 12, wherein a third pattern is disposed between the first pattern and the second pattern, the third pattern corresponding to another channel.

14. The terminal of claim 10, wherein the first threshold value is set according to a number of patterns having a capacitance value greater than or equal to the first threshold value detected as the touch input approaches the touch panel.

15. The terminal of claim 10, wherein identification information of the corresponding channel is assigned to the first pattern and separate pattern information is generated and assigned to the second pattern.

16. The terminal of claim 10, wherein if the processing unit determines that the second sensing coordinates are positioned within the first sensing coordinates, the sensing coordinates are determined as initial coordinates.

17. The terminal of claim 16. wherein if the touch panel detects a change in the first sensing coordinates, the processing unit determines whether the changed first sensing coordinates are within a reference proximity of the initial coordinates, and determines the changed first sensing coordinates as valid first sensing coordinates if the changed first sensing coordinates are determined to be within the reference proximity of the initial coordinates.

18. The terminal of claim 16. wherein if the touch panel detects a change in the second sensing coordinates, the processing unit determines whether the changed second sensing coordinates are within a reference proximity of the initial coordinates, and determines the changed second sensing coordinates as valid second sensing coordinates if the changed second sensing coordinates are determined to be within the reference proximity of the initial coordinates.

19. The terminal of claim 10, wherein the capacitance value is greater than or equal to the second threshold value if the touch input contacts the touch panel.

20. A terminal, comprising:
a touch panel to detect a capacitance value associated with a touch input; and
a processing unit to sense a coordinate on the touch panel corresponding to the capacitance value, and to determine validity of the coordinate based on the capacitance value,
wherein the touch panel comprises a plurality of channels with at least one channel comprising a plurality of patterns.
